(19) United States
(12) Patent Application Publication
(10) Pub. No.: US 2006/0163012 A1
(43) Pub. Date: Jul. 27, 2006

(54) Brake for vehicle wheels provided with constraining elements of the elastically operating braking band

(76) Inventors: Bruno Greppi, Erba CO (IT); Cesare Brioschi, Galbiate LC (IT)

Correspondence Address: JACOBSON HOLMAN PLLC, 400 SEVENTH STREET N.W., SUITE 600, WASHINGTON, DC, 20004, US

(21) Appl. No.: 11/337,479

(22) Filed: Jan. 24, 2006

(30) Foreign Application Priority Data
Jan. 25, 2005 (IT) MI2005U 000016

(51) Int. Cl. F16D 65/40

(52) U.S. Cl. 188/73.38

(57) ABSTRACT

A brake for vehicle wheels comprises a first element integral with the wheel and a second element comprising an annular strip on which brake pads act, said first and second element having respective hollow portions intended to correspond to pairs for forming receiving seats of constraining elements; the constraining element consists of a substantially cylindrical pawl around the side surface of which an elastically deformable annular element is arranged intended to remain interposed between the wall of the seat and the side wall of the pawl to enable corresponding movements between the hollow portion of the first element and the hollow portion of the second element of the brake.

### BACKGROUND OF THE INVENTION

1. Field of the Invention

The present invention relates to a brake for vehicle wheels provided with a particular constraining element between the braking band (consisting, for example, of a disc) on which the brake pads and the wheel to be braked act.

2. State of the Prior Art

In the field of vehicles, in particular of motorcycles, fixing the disc of the brake to the hub of the wheel to be made to brake using a series of constraining elements has been known for some time, for example rivets and studs, spaced at regular intervals along the internal circumference of the disc.

To achieve fixing, each rivet can be received in a suitable generally cylindrical seat defined by a pair of aligned coaxial holes obtained respectively on the hub of the wheel (or on a brake element fixed to the hub) on the braking disc.

Alternatively, each rivet can be received in a seat half defined by a generally semicylindrical concavity obtained on the hub and half defined by a similar semicylindrical concavity obtained on the disc.

In all cases, fixing achieved with prior-art rivets imposes rigid constraining of the disc on the hub at several points, generating some significant drawbacks.

In fact, during braking, great tension inside the braking track of the disc and considerable local temperature increases due to friction are generated; these phenomena may cause local stretching in various zones of the disc.

With a system of stiff constraints defining a series of fixed points for the braking track, the local stretching that originates in the disc may cause permanent deformation and curving that, over the long term, may cause damage to the brake, great noise and undesired vibrations.

The general object of the present invention is to overcome the aforementioned drawbacks by providing a brake provided with a constraining system between the element that forms the braking track and the wheel to be made to brake such as to absorb the stretching of the braking track due to mechanical or thermal stress, avoiding permanent deformation or undesired curves.

A further object of the present invention is to provide a constraining element that has both a simple and economical structure.

Another object of the present invention is to provide a constraining element that enables the vibrations and noise of the brake to be reduced.

### SUMMARY OF THE INVENTION

In view of this object it was decided to make, according to the invention, a brake for vehicle wheels comprising a first element coupled with the wheel and a second element comprising an annular strip on which braking pads act, said first and second element having respective hollow portions intended to correspond to pairs for forming receiving seats of constraining elements, characterized in that said constraining element consists of a substantially cylindrical pawl around the side surface of which there is arranged an elastically deformable annular element intended to remain interposed between the wall of the seat and the side wall of the pawl to enable corresponding movements between the hollow portion of the first element and the hollow portion of the second element of the brake.

### BRIEF DESCRIPTION OF THE DRAWINGS

In order to make the explanation of the innovative principles of the present invention and its advantages over the prior art clearer, a possible embodiment applying such principles will be disclosed below with the help of the enclosed drawings. In the drawings:

FIG. 1 is a view of a disc brake according to the invention,

FIG. 2 is a constraining element fixing the disc of the brake to the hub of the wheel, in rest status,

FIG. 3 is a constraining element fixing the disc of the brake to the hub of the wheel, in operating status with stretching deformation of the disc,

FIG. 4 is a section view of the constraining element in the preceding figures, sectioned along the plane IV-IV in FIG. 2,

FIG. 5 is a view of an alternative embodiment of the constraining element according to the invention, sectioned according to a plane perpendicular to the plane of the disc.

### DETAILED DESCRIPTION OF THE INVENTION

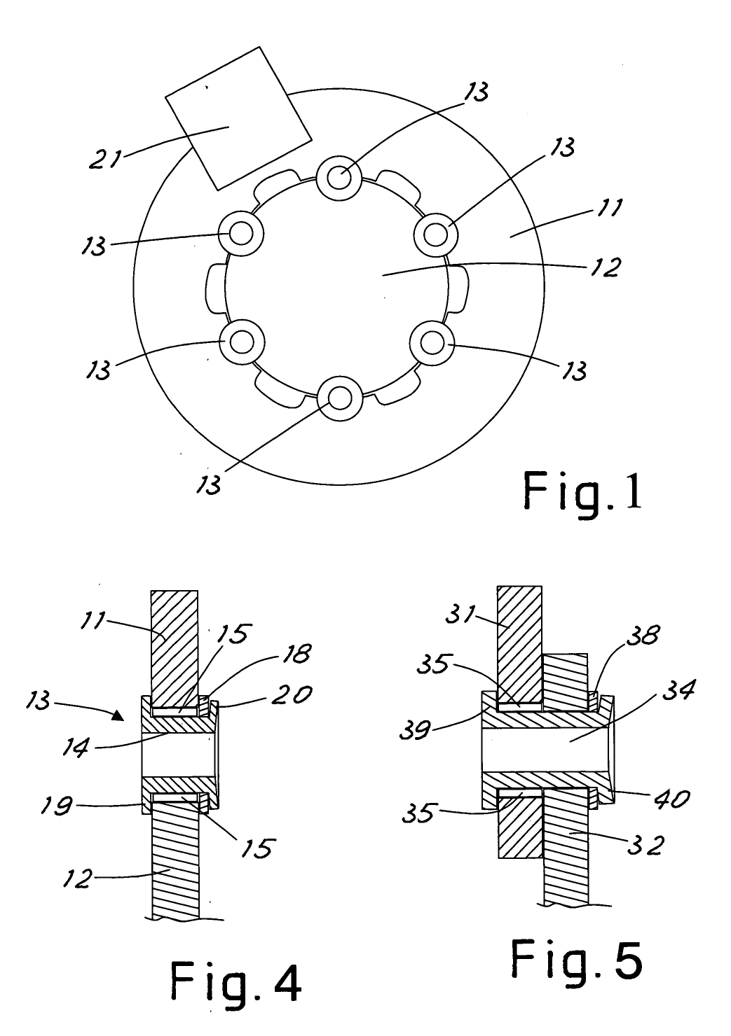

With reference to the figures, in FIG. 1 there is shown the disc 11 of a disc brake, mounted on an element 12 fixed to the hub of a wheel to be made to brake (not shown in the figure) for example of a motorcycle.

The disc of the brake 11 forms an annular braking track intended to cooperate with the braking pads 21 (shown schematically in the figure) to achieve the braking action of the wheel, according to techniques known in the brakes field.

The disc of the brake 11 has an annular shape and is fixed to the element 12 that is coupled with the wheel by means of a plurality of constraining elements 13 spaced in a regular manner along the internal perimeter of the disc 11.

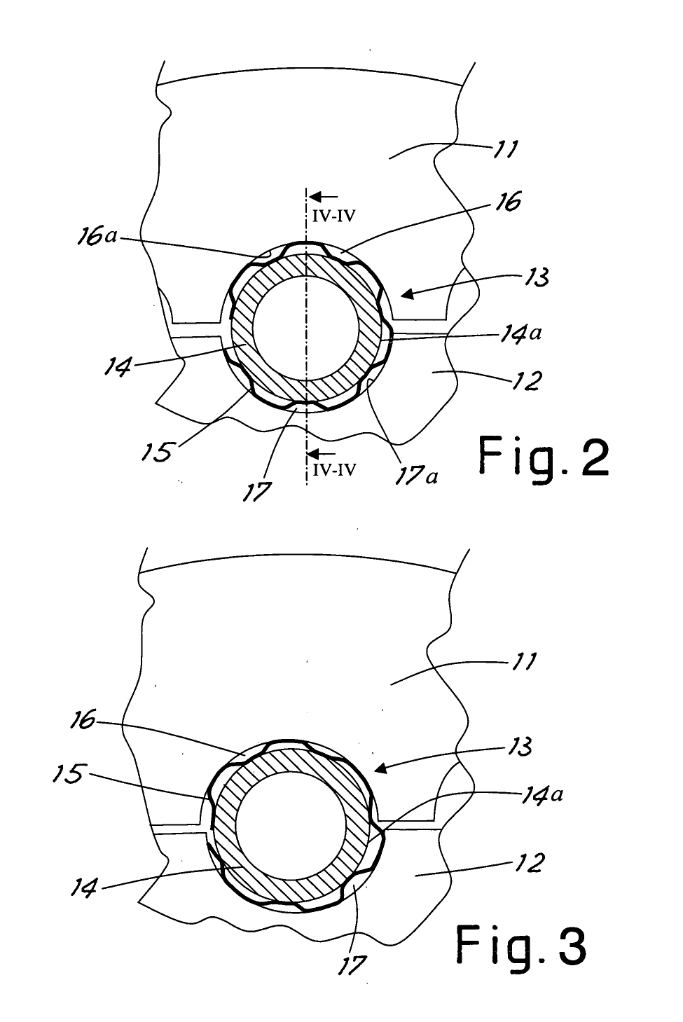

In FIG. 2 a constraining element 13 between the braking disc 11 and the element 12 coupled with the wheel is shown in detail. The element 13 comprises a pawl 14 (shown in the figure with the head removed) received in a seat defined by an open hollow portion 16 of the disc and by an open hollow portion 17 of the element 12 arranged facing the hollow portion 16 of the disc 11.

Around the side surface 14a of the pawl 14, an elastically deformable annular element 15 is arranged. The annular element 15 remains interposed between the side wall 14a of the pawl 14 and the wall 16a, 17a of the seat in which the constraining element 13 is received, and according to the invention, ensures constraining of the disc on the hub, whilst enabling the disc to stretch locally between constraint and constraint, assisting the deformation thereof (due for example to thermal or mechanical stress).

In FIG. 4 a section of the constraining element 13 according to plane IV-IV in FIG. 2 is shown. The pawl 14 (or “pin”), made in the shape of a hollow cylinder, is provided at the ends with a head 19 and with a head 20 for achieving the constraint between the disc 11 and the element 12 in a direction that is perpendicular to the disc of the brake.

According to prior-art solutions, the second head 20 of the pawl 14 could be obtained by riveting, for example with the interposing of a washer 18 between the head 20 and the wall of the disc brake. As an alternative to riveting the head, to make the constraint in the direction that is axial to the pawl, a clip or Seeger ring could be applied to the pawl, according to known solutions in the field of disc brakes.

In an embodiment of the invention, the annular element 15 is made from a band of elastic metal material (see FIG. 2).

The band 15, sectioned on a plane parallel to the disc, has an undulating pattern to alternatively touch the wall of the seat 16a, 17a and the side wall 14a of the pawl 14.

As shown in the figure, the band 15 is such as to touch at at least three different points the wall 16a of the hollow portion 16 of the disc and at at least three points the wall 17a of the hollow portion 17 of the element 12. According to what is shown in FIG. 2, in the rest position with the annular element in the non-deformed position, the pawl 14 (cylindrical in shape) is coaxial to the generally cylindrical seat formed by the hollow portions 16 and 17. Furthermore, the disc 11 is not in direct contact with the element 12, there being a small gap between the two elements. It should be noted that “generally cylindrical seat” also refers to seats that have a certain degree of conicity, due, for example, to blanking of the seats.

Advantageously, the band 15 does not surround the pawl 14 along its entire side surface 14a, but has a notch that is longitudinal to the axis of the pawl. This solution enables the band 15 to extend along the perimeter of the pawl 14 when it is compressed and deformed during a corresponding movement between the hollow portion 16 of the disc 11 and the hollow portion 17 of the element 12 or when the constraining element is inserted into its seat by pressing it to impose the necessary preload on the elastic band. As already mentioned, the disc 11 of the brake is in fact subjected to considerable mechanical and thermal stress due to the action of friction braking on the braking track. The stresses can cause local stretching of the disc 11 that vary the distances between two adjacent hollow portions 16 and 17 intended for constraining the disc on the hub.

The annular elastic element 15 absorbs this stretching, enabling reciprocal movement between the hollow portion 16 and the element 12, preventing curving of the disc.

FIG. 3 shows how the band 15 is deformed by local movement of the braking track 11 to the left.

The band 15 acts elastically and, when thermal-mechanical stress has terminated, recovers the original position in FIG. 2, preventing the occurrence of deformation of a permanent type on the disc.

The elastic action of the annular element 15 enables all the mechanical and thermal stretching generated by braking on the disc 11 to be absorbed, thus ensuring the planarity of the disc in all work conditions.

It should be noted that the annular element enables stress from different angular tilts (both radial and tangential or combinations of the two) to be absorbed.

FIG. 5 shows an alternative embodiment of the present invention, where the pawl 34 is received in a generally cylindrical seat defined by a pair of aligned coaxial closed holes respectively obtained on the element coupled with the wheel 32 and on the disc of the brake 31.

The pawl 34, as in the preceding case, is provided with a first head 39 and with a riveted head 40 for ensuring the constraint between disc and hub in an axial direction. A washer 38 can be arranged between the riveted head 40 and the element 32, according to known techniques in the field of disc brakes.

In the embodiment in FIG. 5 the annular elastic element 35, shown schematically in the figure, surrounds the pawl 34 only on the part thereof received in the hole on the disc 31. In this way the pawl is rigidly constrained on the element 32, but the disc 31 has a small degree of freedom compared with the pawl, being able to “fluctuate” around the latter, exploiting the deformability of the annular element 35.

It should be noted that the element 35 could be made with an undulating band completely similar to the band disclosed for the main embodiment in FIG. 2.

At this point it is clear how the objects of the present invention have been achieved.

A brake has in fact been provided that is provided with constraining elements fixing the disc of the brake to the wheel to be made to brake that enable the disc to stretch locally between constraint and constraint without undergoing deformation of a permanent nature and without losing planarity.

Lastly, a constraining element has been provided that dampens all the vibration that may be induced on the disc and considerably limits the noise from rolling of the brake. Naturally, the above disclosure of an embodiment applying the innovative principles of the present invention is provided by way of example of such principles and must not therefore be taken to limit the scope of the invention claimed herein. The longitudinal notch formed in the elastic band could also not be rectilinear, but could be V-shaped, in order to obtain continuous contact between the wall of the seat and the band along the entire perimeter of the pawl.

The band may also be peripherally continuous, so without the interruption created by the longitudinal notch, in particular if the radial undulations thereof are accentuated to the point of any way conferring the necessary deformability on the ring.

What is claimed is:

1. Brake for vehicle wheels comprising a first element coupled with the wheel and a second element comprising an annular strip on which braking pads act, said first and second element having respective hollow portions intended to correspond to pairs for forming housing seats of constraining elements, characterized in that said constraining element consists of a substantially cylindrical pawl around the side surface of which an elastically deformable annular element is arranged intended to remain interposed between the wall of the seat and the side wall of the pawl to enable corresponding movements between the hollow portion of the first element and the hollow portion of the second element.

2. Brake according to claim 1, characterized in that said hollow portions are open concavities intended to be made to face one another in pairs to define a hole that makes said housing seat of the constraining element.

3. Brake according to claim 1, characterized in that said seat is a through hole and the constraining element is provided with a head on each of the two ends protruding on opposite sides of the seat, to make the connection between the first and the second element in an axial direction in relation to the pawl.

4. Brake according to claim 3, characterized in that a head is obtained for riveting the pawl inserted into the seat.

5. Brake according to claim 1, characterized in that said annular element is made of an elastic band, said band being sectioned according to a plane that is perpendicular to the axis of the pawl having an undulating profile for alternatively resting on the surface of the seat and on the side surface of the pawl.

6. Brake according to claim 5, characterized in that said band has six points of contact with the wall of the seat and six points of contact with the side surface of the pawl.

7. Brake according to claim 5, characterized in that said band has a notch longitudinally to the pawl to enable the tangential expansion of the band along the perimeter of the pawl through radial deformation within the seat.

8. Brake according to claim 5, characterized in that the elastic band is made of metal material.

9. Brake according to claim 1, characterized in that said seat is generally circular cylindrical.

10. Brake according to claim 1, characterized in that said pawl is circular cylindrical.

11. Brake according to claim 9, characterized in that said pawl is circular cylindrical and in that when the annular element is in the non-deformed position the pawl is coaxial to said seat.

12. Brake according to claim 2, characterized in that the two brake elements are not in direct contact with one another when the annular elastic element is in the non-deformed position.

13. Brake according to claim 1, characterized in that said hollow portions are closed holes obtained respectively in the first and the second element, intended to be aligned in pairs when they correspond to form said receiving seat of the constraining element.

14. Brake according to claim 13, characterized in that the annular element is arranged between the side wall of the pawl and the internal wall of only one of the two holes that form the seat.

15. Brake according to claim 1, characterized in that the second element of the brake is a disc.

16. Brake according to claim 1, characterized in that the first element of the brake is fixed to the hub of the wheel to be made to brake.

17. Brake according to claim 3, characterized in that a head of the pawl is obtained by applying a clip or a Seeger ring to the pawl.

18. Brake according to claim 7, characterized in that the longitudinal notch in the elastic band is V-shaped, to ensure the continuity of the contact between the wall of the seat and the band along the perimeter of the pawl.

19. Brake according to claim 5, characterized in that the band has a continuous profile for surrounding the side wall of the pawl without interruptions or notches.
